(19) United States
(12) Patent Application Publication
(10) Pub. No.: US 2016/0086127 A1
(43) Pub. Date: Mar. 24, 2016

(54) METHOD AND SYSTEM FOR GENERATING INTERACTION DIAGRAMS FOR A PROCESS

(71) Applicant: Wipro Limited, Bangalore (IN)

(72) Inventors: Nithya Ramkumar, Bangalore (IN); Amit Vikram, Bangalore (IN); Subodh Purushottam Kawadkar, Bangalore (IN); Nilesh Ramesh Metkar, Bangalore (IN); Thangaprakash Kanagaraj, Chennai (IN); Ravi Krishnan Lakshmi Narasimhan, Pune (IN)

(21) Appl. No.: 14/536,959

(22) Filed: Nov. 10, 2014

(30) Foreign Application Priority Data
Sep. 22, 2014 (IN) 4590/CHE/2014

(51) Int. Cl. G06Q 10/06; G06F 9/48; G06F 3/0484

(52) U.S. Cl. CPC G06Q 10/063118; G06F 3/04842; G06F 9/4881

(57) ABSTRACT

A method and system that generates an interaction diagram for a process. First step of the method comprises determining selection of a process by a user through a user interface. Second step of the method comprises obtaining parameters related to the selected process from a memory. Third step of the method comprises displaying the parameters associated with the selected process on the user interface. Fourth step of the method comprises evaluating properties and corresponding inter-relations of the parameters for at least one of selected sub-process and one or more activities of the process. Fifth step of the method comprises indicating the parameters related to at least one of the selected sub-process and one or more activities of the selected process to generate interaction diagram for the process.

This application claims the benefit of Indian Patent Application No. 4590/CHE/2014 filed Sep. 22, 2014, which is hereby incorporated by reference in its entirety.

### FIELD

The present subject matter is related, in general to interaction diagrams and more particularly, but not exclusively to a method and a system for generating interaction diagrams for a process.

### BACKGROUND

Today, in business process management domain, a lot of business interactions take place among different people. An interaction diagram captures these business interactions by describing the data flow and the messages exchanged within a business process. The interaction diagram is a very useful tool that adds value to the modeling of business structures and processes. The capturing and detailing of all business interactions is critical activity for various fields like process transformation initiatives, outsourcing and business restructuring etc. The business staff could use such diagrams to communicate how exactly the business currently works by illustrating how the different business objects interact.

Currently used applications capturing the business interactions are either focused on process flow execution using Business Process Model and Notation (BPMN) tools or system flow execution. The current solutions are best suited to the portrayal of simple interactions among relatively small numbers of objects. As the number of objects and messages grows, the diagrams created by current solutions can become difficult to read.

One disadvantage of current interaction diagrams is that they do not provide explicit indication which objects execute which activities, and the way that the messaging works between them. Further, it is difficult to identify the key interaction between the business documents, role and system within the selected process context in the current solutions. Also, interactions are viewed from different angles such as people, process and technology separately residing in various applications which makes it difficult to determine the existing relationship between them. Also, the current solutions to generate interaction diagrams are time consuming and may become unwieldy for large projects.

### SUMMARY

One or more shortcomings of the prior art are overcome and additional advantages are provided through the present disclosure. Additional features and advantages are realized through the techniques of the present disclosure. Other examples and aspects of the disclosure are described in detail herein and are considered a part of the claimed disclosure.

Disclosed herein is a method for generating interaction diagrams for a process. The method comprises determining selection of a process by a user through a user interface. Then, the method comprises obtaining parameters related to the selected process from a memory and displaying the parameters associated with the selected process on the user interface. The method further comprises evaluating properties and corresponding inter-relations of the parameters for at least one of selected sub-process and one or more activities of the process. Then, the method comprises indicating the parameters related to at least one of the selected sub-process and one or more activities of the selected process to generate interaction diagram for the process.

In an aspect of the present disclosure, a system for generating interaction diagrams for a process is disclosed. The system comprises a processor and a memory communicatively coupled to the processor. The memory stores processor-executable instructions which on execution, causes the processor to determine selection of a process by a user through a user interface. The processor obtains parameters related to the selected process from a memory and displays the parameters associated with the selected process on the user interface. The processor is further configured to evaluate properties and corresponding inter-relations of parameters for at least one of selected sub-process and one or more activities of the process. Also, the processor indicates the parameters related to the at least one of the selected sub-process and one or more activities of the selected process to generate interaction diagram for the process.

In another aspect of the present disclosure, a non-transitory computer readable medium for generating interaction diagrams for a process is disclosed. The non-transitory computer readable medium includes instructions stored thereon that when processed by a processor causes a system to perform one or more acts. First act is determining selection of a process by a user through a user interface. Then, obtaining parameters related to the selected process from a memory and displaying the parameters associated with the selected process on the user interface. Next, act is evaluating properties and corresponding inter-relations of the parameters for at least one of selected sub-process and one or more activities of the process. Lastly, indicating the parameters related to the at least one of the selected sub-process and one or more activities of the selected process to generate interaction diagram for the process.

The foregoing summary is illustrative only and is not intended to be in any way limiting. In addition to the illustrative aspects, examples, and features described above, further aspects, examples, and features will become apparent by reference to the drawings and the following detailed description.

### BRIEF DESCRIPTION OF THE DRAWINGS

The accompanying drawings, which are incorporated in and constitute a part of this disclosure, illustrate exemplary examples and, together with the description, serve to explain the disclosed principles. In the figures, the left-most digit(s) of a reference number identifies the figure in which the reference number first appears. The same numbers are used throughout the figures to reference like features and components. Some examples of system and/or methods in accordance with examples of the present subject matter are now described, by way of example only, and with reference to the accompanying figures, in which:

FIG. 1 illustrates a block diagram of system for generating interaction diagrams for a process in accordance with some examples of the present disclosure;

FIG. 2 illustrates a block diagram of ID generator module for generating interaction diagrams for a process in accordance with some examples of the present disclosure;

FIG. 3 illustrates a flowchart showing method for creating and managing interaction diagrams for a process in accordance with some examples of the present disclosure;

FIG. 4 illustrates a flowchart showing method for generating interaction diagrams for a process in accordance with some examples of the present disclosure; and

FIG. 5A to 5L illustrate exemplary representation of snapshots for generating interaction diagrams for a process for implementing examples consistent with the present disclosure.

FIG. 6 illustrates a block diagram of an exemplary computer system for implementing examples consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Embodiments of the present disclosure are related to a method and a system for generating business interaction diagrams for a process. In an embodiment, the user of the system selects a process for creating the interaction diagrams. The parameters of the selected process are defined along with their properties and inter-relations. In an embodiment, the parameters could be document, roles and system for the selected process with interactions between them. Then, one or more activities and sub-processes are created using the parameters. The creation of activities and sub-processes comprises defining flow properties and updating parameters of the process. Then, one or more users can view details of one or more activities and sub-processes which are selected by the user. Also, all the interactions between different processes and parameters are provided to the user. The interaction diagram also captures exceptional situations in the flow of interaction diagram.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

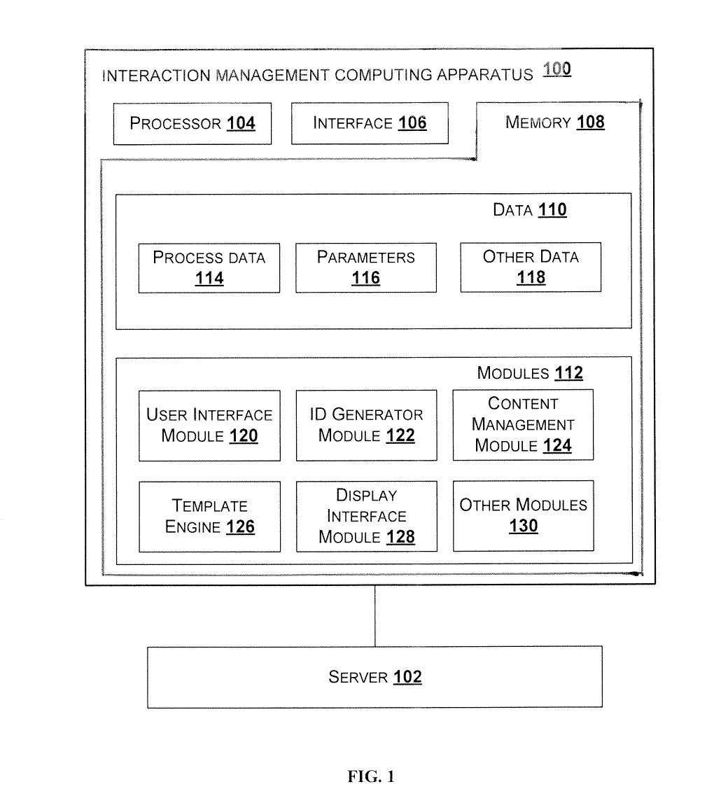

FIG. 1 illustrates a block diagram of system for generating interaction diagrams for a process in accordance with some embodiments of the present disclosure.

The system 100 may be implemented in a variety of computing systems, such as a desktop computer, a portable computer, a mobile phone, a handheld device, a workstation. The system 100 generates interaction diagrams for a process, for example a business process. In an embodiment, the system 100 is configured to receive details related to a process for creating interaction diagrams. The system 100 is communicatively connected to a server 102 through a network (not shown in FIG. 1).

Examples of the server 102 include, but are not limited to, a laptop computer, a desktop computer, a notebook, a workstation, a mainframe computer, a server, a network server, and the like. In an embodiment, the business process refers to a program module which includes, but is not limited to, test cases, tasks, executable instructions, program codes, implementation steps, functions and structured activities. For example, an employee may view the interaction diagram to understand business process/structure of a company.

The server 102 provides resources to load the application for generating and viewing business interaction diagrams. Also, the server 102 authenticates the request of user of system 100 to access the application for generating interaction diagrams. In an embodiment, the server 102 authenticates the user based on the login credentials provided by the user.

In one implementation, the system 100 includes a central processing unit (“CPU” or “processor”) 104, an input/output (I/O) interface 106 and a memory 108. The processor 102 may comprise at least one data processor for executing program components and for executing user- or system-generated queries. The I/O interface 104 is coupled with the processor 102 through which the data like parameters of business processes are received. The memory 108 is communicatively coupled to the processor 104. The memory 108 stores application and processor-executable instructions for generating interaction diagrams for a business process.

In an embodiment, the system 100 receives data 110 relating to the business process. In one example, the received data 110 may be stored within the memory 108. In one implementation, the data 110 may include, for example, process data 114, parameters 116, and other data 111.

In an embodiment, the process data 114 comprises information about one or more processes in a business. For example, a bank company may have different processes for opening an account, depositing a cheque, withdrawal of cash and the like. In another example, an accounts payable department may have different processes for receiving, processing and making payment to vendors. The interactions occurring along these activities might vary based on different parameters of the process.

The parameters 116 are parameters of a business process. The parameters of a business process may include, but are not limited to, document, roles, system and goals. The parameters are stored along with their properties and inter-relations with other parameters. The parameters are used to define the business process clearly and in an understandable manner.

In one embodiment, the data 110 may be stored in the memory 108 in the form of various data structures. Additionally, the aforementioned data 108 may be organized using data models, such as relational or hierarchical data models. The other data 108 may be used to store data, including temporary data and temporary files, generated by the modules 112 for performing the various functions of the interaction management computing apparatus 100. In an embodiment, the data 110 received from the user are processed by the modules 112 of the interaction management computing apparatus 100. The modules 112 may be stored within the memory 108.

In one implementation, the modules 112 may include, for example, user interface module 120, Interface Diagram (ID) generator module 122, content management module 124, template engine 126 and display interface module 126. The interaction management computing apparatus 100 may also comprise other modules 130 to perform various miscellaneous functionalities of the interaction management computing apparatus 100. It will be appreciated that such aforementioned modules may be represented as a single module or a combination of different modules. In an embodiment, the modules 112 are implemented on a browser.

The user interface module 120 provides an Application Programming Interface (API) for providing interactive user interfaces of integration diagrams. The user interface module 120 helps the user to create a business process comprising activities and sub-processes, Also, the user interface module 120 provides for creating parameters like document, roles and system with associated attributes and/or properties. The user interface module 120 additionally provides with options to define scope of business process, process detailing level. In an embodiment, the user interface module 120 is implemented using one or more browser supported technologies. As an example, the technologies may include Hyper Text Markup Language 5 (HTML5), Cascading Style Sheets (CSS3), JavaScript, Scalable Vector Graphics (SVG) etc.

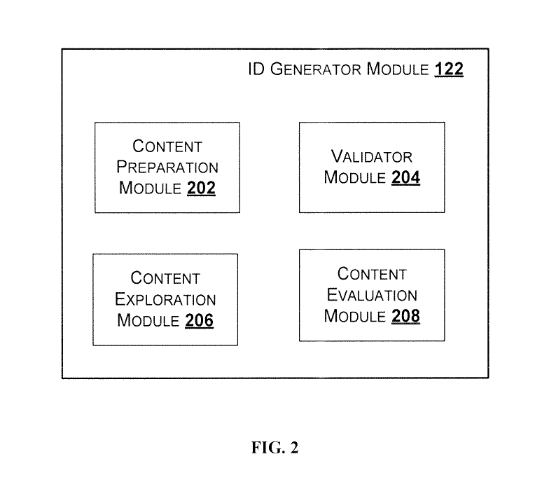

The ID generator module 122 generates the integration diagram using parameters/process flow properties, defined scope, process detailing level and inter-relations between the parameters. The ID Generator Module 122 interacts with the user interface module 120 for generation of interaction diagram views based on the users request on the browser. In an exemplary embodiment, browser is a software application to access the information available on World Wide Web. As an example, the browser such as Chrome, Firefox, Internet Explorer, Opera and Safari are supported. The ID generator module 122 retrieves data 110 through the content management module 124. In an embodiment, the ID generator module 122 comprises one or more modules for generation of interaction diagrams, as illustrated in FIG. 2. The one or more modules are content preparation module 202, validator module 204, content exploration module 206 and content evaluation module 208.

The content preparation module 202 transforms the received content through the content management module 124. Also, the content preparation module 202 interacts with the validator module 204 for validation of content.

The validator module 204 validates the content for errors and missing information to generate the interaction diagram. The errors and missing information will be shown to user using the display interface module 128 and content has to fix using the user interface module 120.

The content exploration module 206 searches and retrieves matching information based on user's request. The content prepared by the content preparation module 202 is used by the content exploration module 206 for searching the relevant information.

The content evaluation module 208 evaluates the matching quantitative information such as number of parameters that have impact on process and vice versa. Also, the content evaluation module 208 evaluates qualitative information such as inter-relations between the parameters like interaction between different document, roles and systems in a process. The evaluated information is passed to the display interface module 128 for displaying the business interaction diagram on to a browser with the help of the user interface module 120.

Referring back to FIG. 1, the content management module 124 assists in retrieving and/or storing of information such as process information, details of parameters from and/or into the memory. The content management module 124 acts as a layer of abstraction between the application and the memory.

The template engine 126 provides method for building dynamically reusable User Interface (UI) elements called templates. The templates are small components that can be composed to form rich user interface.

In an embodiment, the display interface module 128 renders the integration diagram on the browser. The display interface module 128 uses data provided by ID Generator module 122 and the template engine 126 to display the information required by the user. The display interface module 128 retrieves integration diagram through the ID generator module 120 using content management module 124. The retrieved integration diagram is displayed using the user interface module 120 onto the browser. The display interface module 128 interacts with the template engine 126 to display process detailing level, process scope, updating of display of parameters and flow properties.

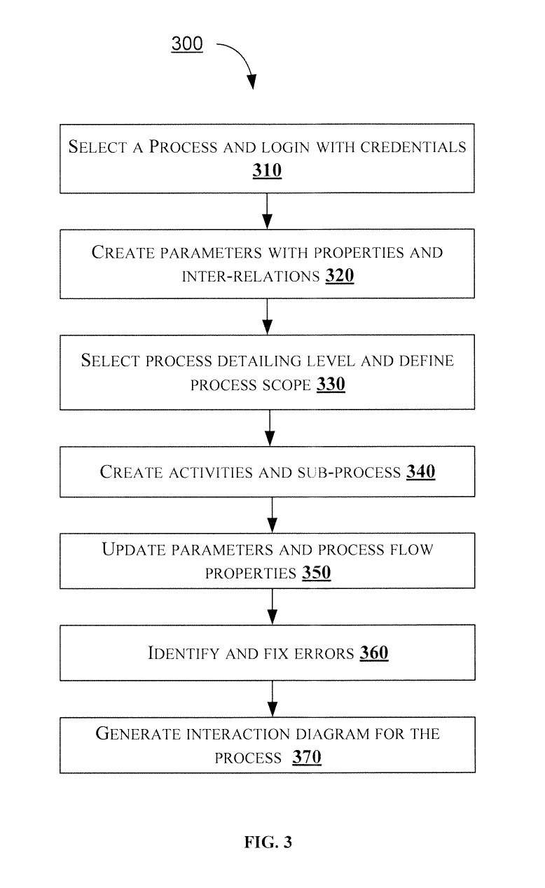

FIG. 3 illustrates a flowchart showing method for creating and managing interaction diagrams for a process in accordance with some embodiments of the present disclosure.

As illustrated in FIG. 3, the method 300 comprises one or more blocks for creating and managing interaction diagrams for a process by the interaction management computing apparatus 100. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method 300. Additionally, individual blocks may be deleted from the method 300 without departing from the spirit and scope of the subject matter described herein. Furthermore, the method 300 can be implemented in any suitable hardware, software, firmware, or combination thereof.

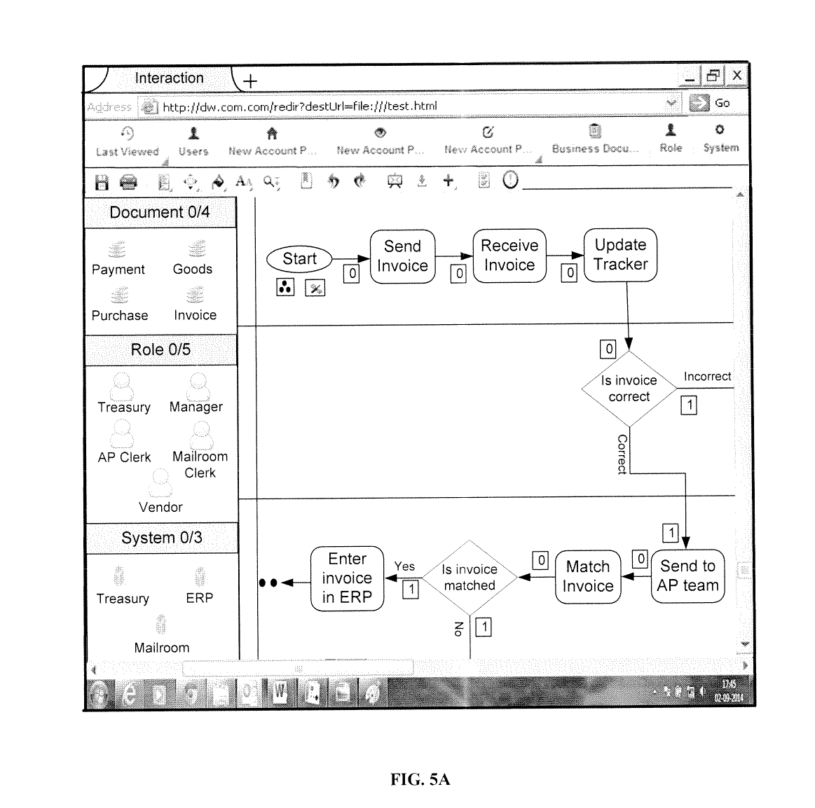

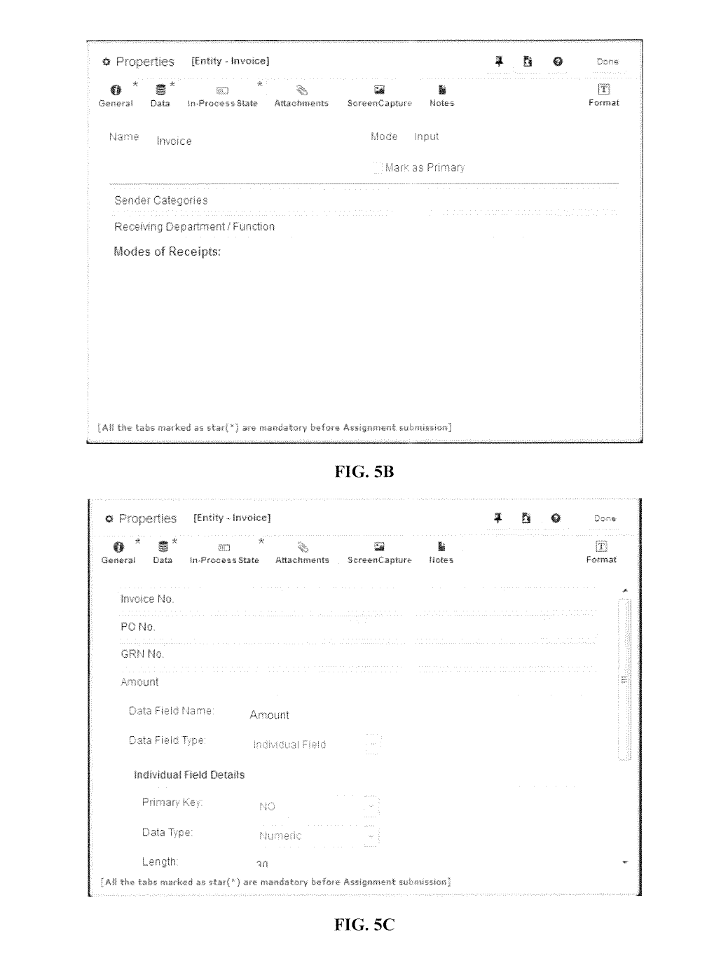

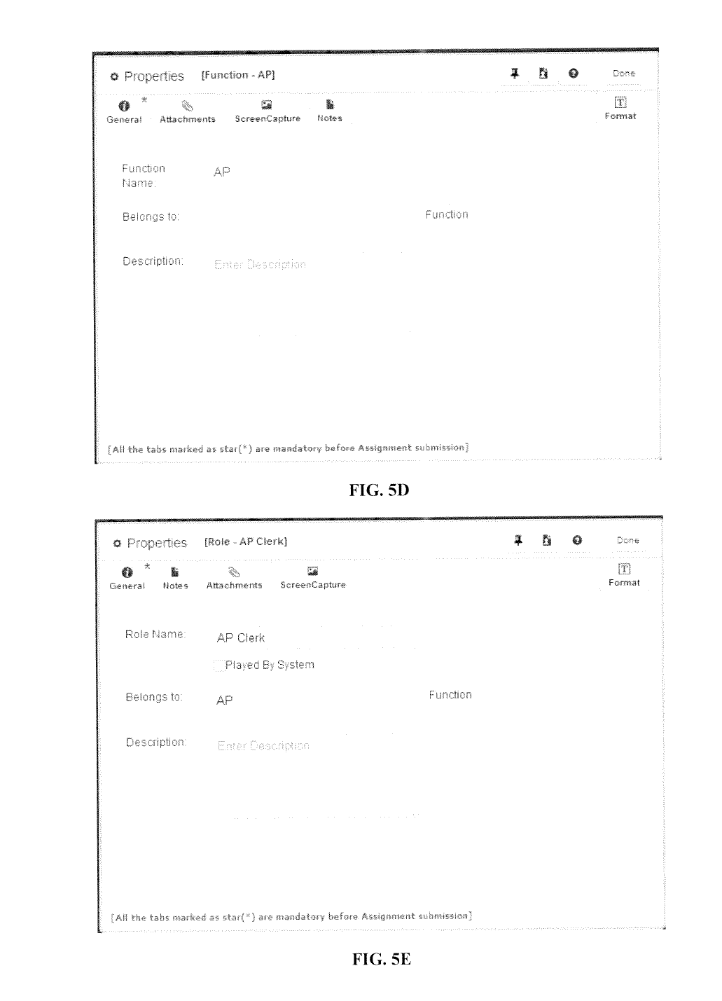

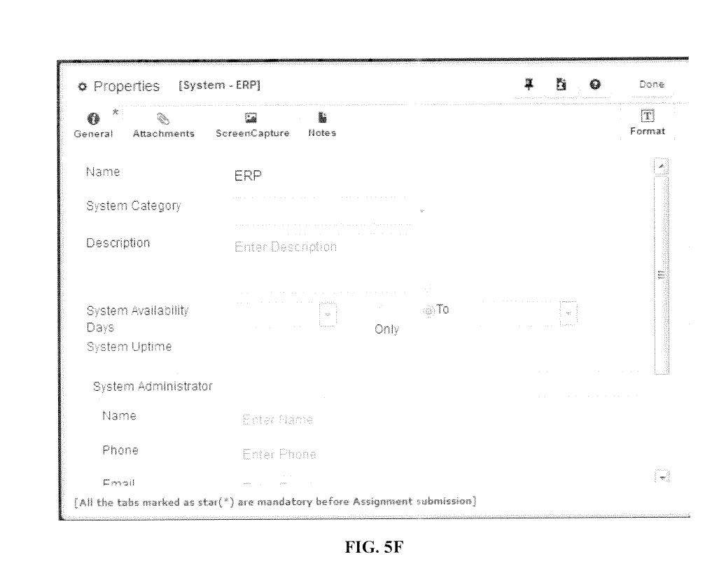

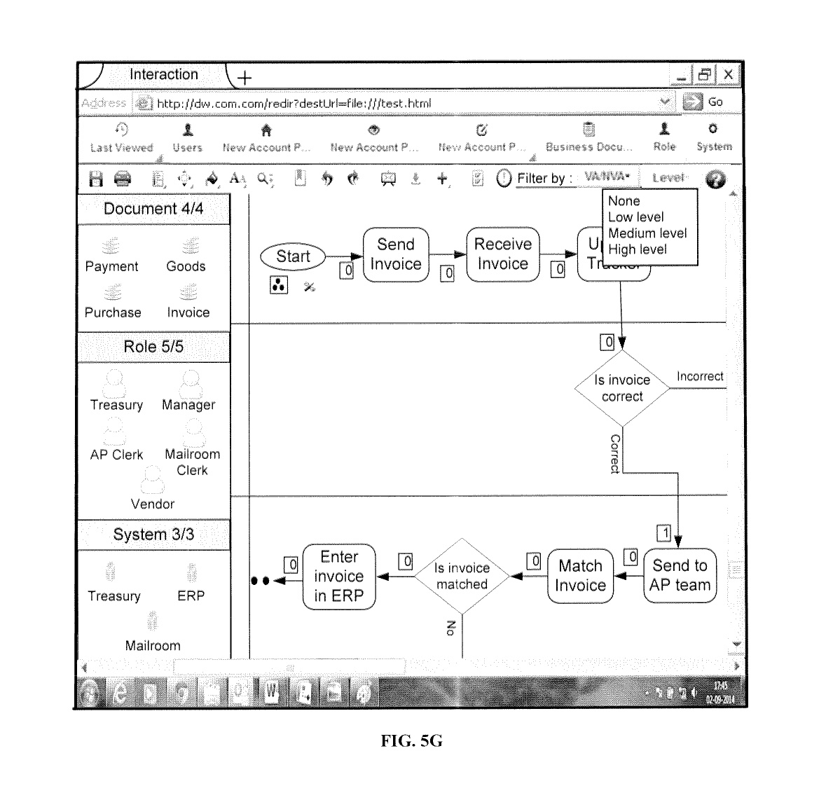

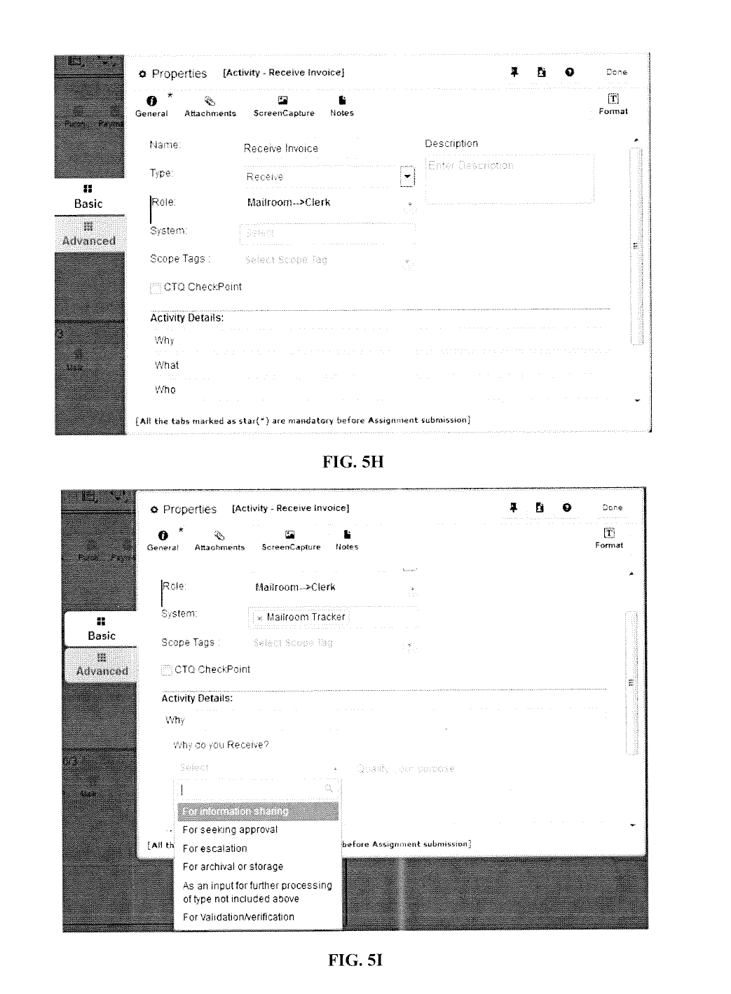

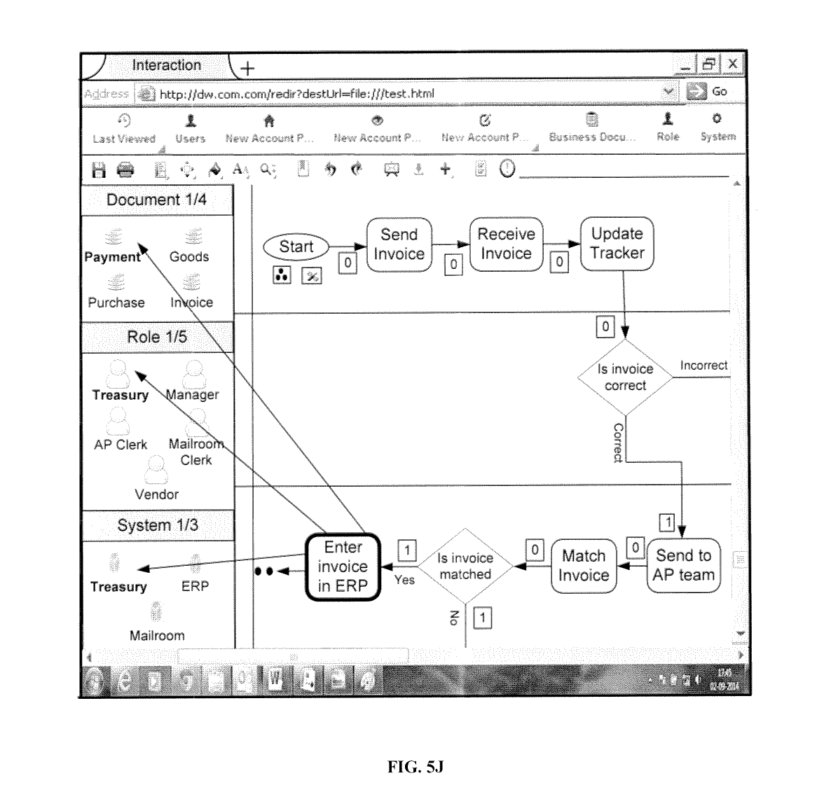

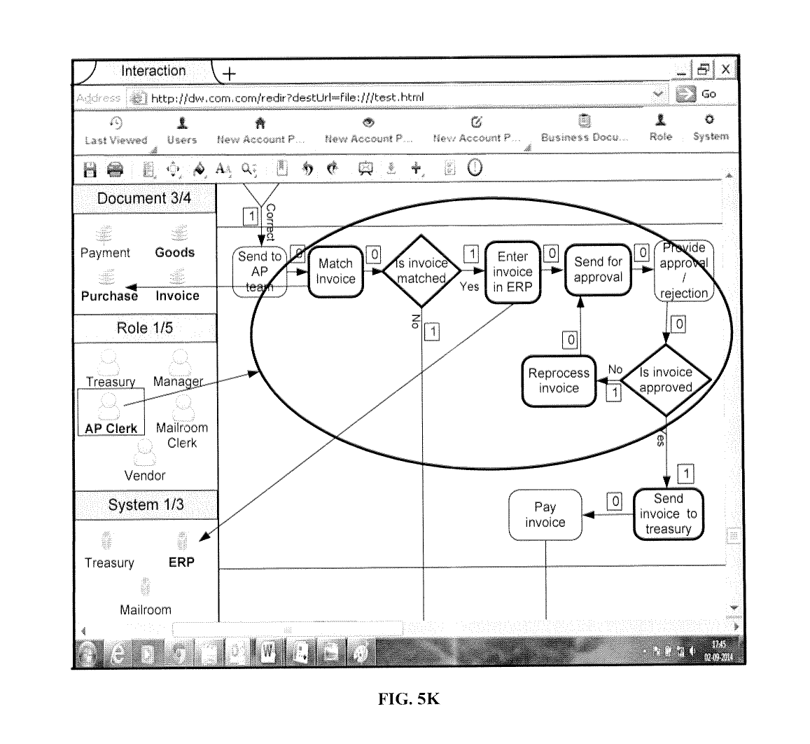

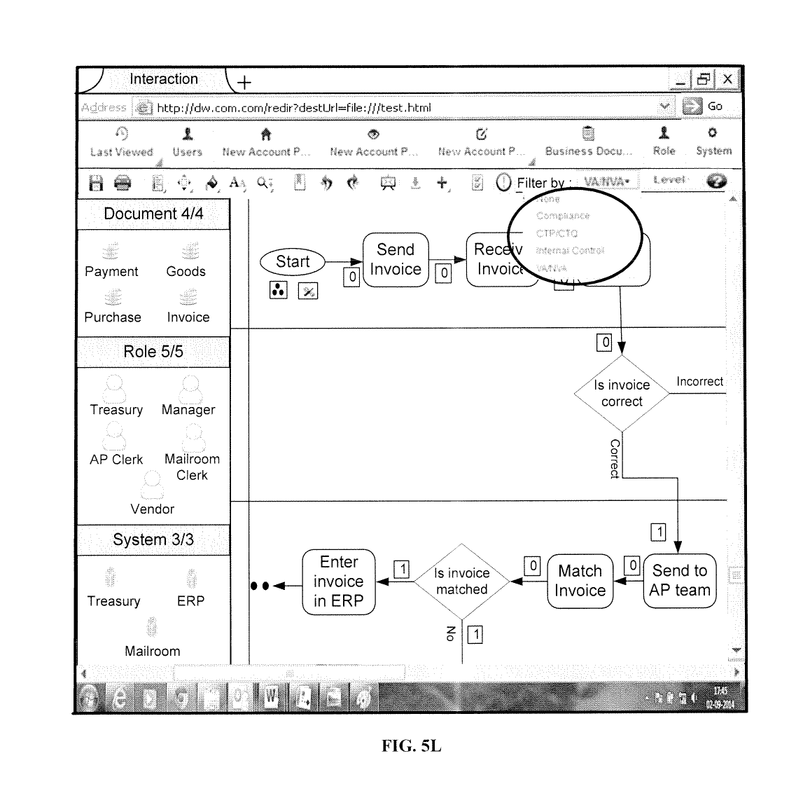

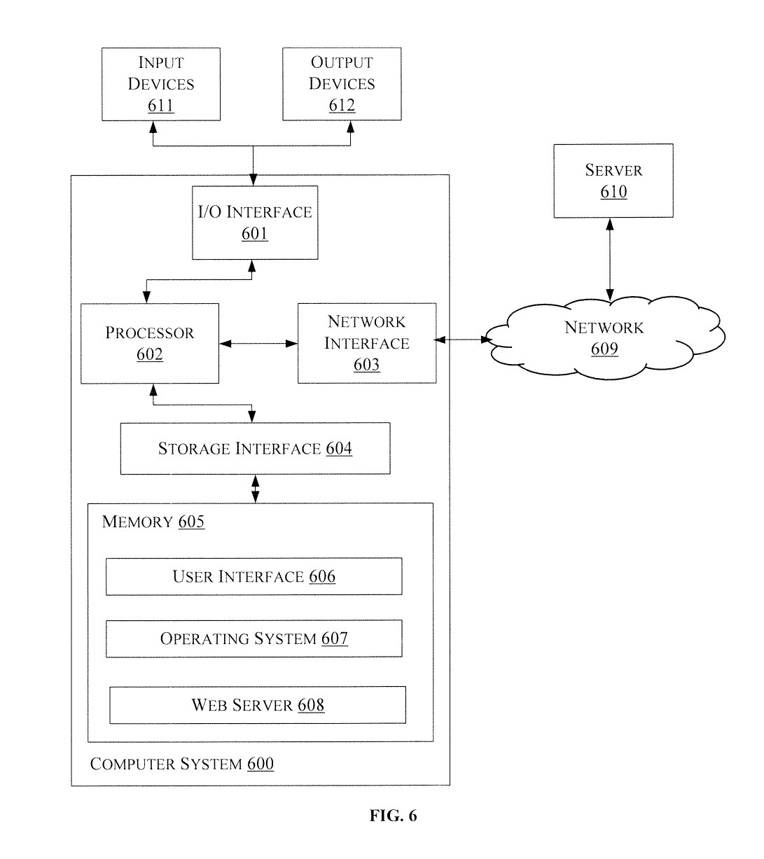

At block 310, select a process and login with credentials. In an embodiment, the user logs into the application on the interaction management computing apparatus 100 through the user interface module 120. The user logs into the application using the credentials provided by the system administrator. The credentials provided by the user are transmitted to the server 104 for validation. Once the credentials of the user are validated, the server 104 provides a list of accounts the user has access to. The user selects a specific account using the user interface module 120. The interaction management computing apparatus 100 provides the home page of the user with the list of projects that user can access through the display interface module 128. The user can then select a project, to document the process for which business interaction diagram needs to be created through the user interface module 120. For example, the user starts the process Accounts Payable on the browser as illustrated by FIG. 5A.

In an Accounts Payable (AP) process scenario, the following process is followed. First, a vendor sends invoices for the services rendered. The invoices are received at mailroom department by a mailroom-clerk. The mailroom-clerk makes an entry in mailroom tracker for the received invoices. Then, the invoices are validated for correctness by the mailroom-clerk. If the invoices are invalid, the mailroom-clerk sends the invoices back to the vendor. But, if the invoices are valid, the mailroom-clerk forwards the invoices to an AP-clerk in Accounts Payable department. The AP-clerk matches the invoice details with Purchase Order (PO) and Goods Receipt Note (GRN). If the invoice details are not matched, the AP-clerk sends the invoice back to the vendor with a rejection note. But, if the invoice details are matched, the AP-clerk updates the invoice in Enterprise Resource Planning (ERP) system and forwards the invoice to AP manager for approval. On approval, the AP-clerk forwards the invoice to treasury-clerk of treasury department to make payment. The treasury-clerk makes payment to the vendor through treasury payment system.

At block 320, create parameters with properties and inter-relations. The user defines the process by creating parameters associated with the process. As an example, the parameters may include document, roles, system, goals and objectives, geography/country/location, service model like Business to Consumer (B2C), Business to Business (B2B) etc., business model like for-profit, non-profit, Non-Governmental Organization (NGO), government, military etc., legal entity/business consolidation structure, regulated/open, product/service context etc. Any other parameters required for defining a process may be used as parameters for the present disclosure. In the following exemplary embodiment, the parameters are considered as document, roles and system. However, the embodiment is not to be construed as limiting the scope of the present disclosure.

Firstly, the interaction management computing apparatus 100 facilitates to provide a definition for the document asset using the user interface module 120. The user can draw a shape on the canvas using the display interface module 128. For creating document parameter related to a process, the interaction management computing apparatus 100 displays the properties that may be captured to define a document asset through the template engine 126. As an example, the information related to document asset may be general properties like name, type, category and format of the document etc., nature of document like input/reference input or output. Further, the information may also include document elements and document types, for example invoice number and date for invoice document asset and document states such as “received, “on hold” etc. The above information is not to be considered as limiting as it is only an indicative list of properties. The template engine 126 is scalable to any level of details.

Then, the user selects inter-relations between data assets through the user interface module 120. For example invoice and Purchase Order (PO) has PO Number as connection data point. FIGS. 5B and 5C illustrate an exemplary representation of screenshots for creating document parameter.

The interaction management computing apparatus 100 facilitates to provide the department/function and role definition of a role asset through the user interface module 120. The user draws a shape of the department and corresponding function though the display interface module 128. The interaction management computing apparatus 100 shows the properties that may be captured to define a role asset through the template engine 126. The properties may include, but are not limited to, general properties like name, type and function of the role etc., contact details, supervisor details and manual or automated, if an activity is performed by a system. The above information is not to be considered as limiting as it is only an indicative list of properties. The template engine 126 is scalable to any level of details. FIGS. 5D and 5E illustrate an exemplary representation of screenshots for creating role parameter. In the illustrated figures, the role created is AP clerk.

The user selects inter-relations between role assets through the user interface module 120. For example, more than one role may be attached to same department/function. For example accountants and Payables Manager can be part of same accounts payable department.

The interaction management computing apparatus 100 facilitates to provide the system definition of a system asset using the user interface module 120. The user draws a shape on the system canvas through the display interface module 128. The interaction management computing apparatus 100 shows the properties that may be captured to define a system asset through the template engine 126. The properties may include, but are not limited to, general properties like system name, type, category of the system asset etc., availability, downtime, system administrators details, reporting manager details, system manuals, licenses, and access restrictions. The above information is not to be considered as limiting as it is only an indicative list of properties. The template engine 126 is scalable to any level of details. FIG. 5F illustrates an exemplary representation of screenshots for creating system parameter. In the illustrated figure, the system created is ERP.

The user selects inter-relations between systems through the user interface module 120. For example, a billing sub-system feeds data into general ledger system on a periodical basis. In an embodiment, the inter-relationships may be unidirectional or bi-directional.

The below table, Table 1 illustrates a list of parameters like document, roles and system used in the process above.

TABLE 1

| Document | Roles | System |
|---|---|---|
| Invoice | Mailroom-clerk | Mailroom Tracker |
| Purchase Order | AP-clerk | ERP |
| Goods Received Note | AP-Manager | Treasury Payment |
| | | System |
| Payment | Treasury-Clerk | |
| | Vendor | |

At block 330, select process detailing level and define process scope for the process. The user selects the level of process detailing through the user interface module 120. As an example, the process detailing levels may include, low level process detailing, medium level process detailing and high level process detailing as illustrated in FIG. 5G. The low level process detailing comprises broad outline of a process and does not necessarily capture all properties of the parameters or process activation. The medium level of process detailing comprises minimum set of data that needs to be captured to create documents using which another person can perform same activity. The high level of process detailing comprises granular most level of data that needs to be captured on the process and parameters.

In an embodiment, the process detailing levels are pre-configured within the interaction management computing apparatus 100 through the content management module 124. In an embodiment, the user is required to provide minimum set of data required at each process detailing level through the user interface module 120 and the template engine 126. Then the data is validated through the validator module 204 of the ID Generator module 122.

In an embodiment, the user provides scope of the process being documented by defining start and stop properties through the user interface module 120.

At block 340, create activities and sub-process for the process. In an embodiment, a highly abstracted version of a process called Generic Process Pattern (GPP) is implemented through the user interface module 120. The exemplary steps in creating activities and sub-processes for a process are described herein.

First, the user selects the process canvas through the user interface module 120. The interaction management computing apparatus 100 then generates and displays swim lanes with one start and one stop shape on the canvas through the display interface module 128. The user selects the start shape through the user interface module 120 and opens properties tab through the template engine 126 via the display interface module 128. The user provides the start properties which include selecting one or more of reasons for start through the user interface module 120. The interaction management computing apparatus 100 provides a list of data assets which can be optionally selected as a reason for the start through the display interface module 128.

Then, the user selects an activity shape from menu and adds to the process canvas with a connection to start or stop or other activity shapes through the user interface module 120. The user places these activities within swim lanes provided by the user interface module 120. The user provides the name of the activity and selects the type of activity from the template engine values displayed by the display interface module 128. In an embodiment, the user selects values for document, roles and systems from the predefined list of document, roles and systems as shown by the template engine 126 using the display interface module 128. In an embodiment, if the value is not available, the parameters and process flow properties are updated. The interaction management computing apparatus 100 then displays questions related to the activity through the template engine 126. As an example, the questions may include, but are not limited to, why, what, who, how, where, when, business rules, business rule changes, instruction sheets, compliance, value addition, exceptions which need special handling, escalation and system. The user provides answers to these questions by entering or selecting values through the user interface module 120. FIGS. 5H and 5I illustrate an exemplary representation of screenshots for creating activities. In the illustrated figures, the activity created is for receiving invoices.

The interaction management computing apparatus 100 then provides a set of flow level properties to be updated based on connections between the activity shapes through the user interface module 120. The user then updates the flow properties which might include normal flow, conditional flow, exception flow and escalation flow. The normal flow comprises sequence of activities which are performed in order one after another. The conditional flow comprises multiple sequences of activities performed based on predefined set of rules such as Yes/No, value greater than/less than, data availability presence/absence etc. The exception flow comprises sequence of activities performed when an abnormal condition occurs such as insufficient data, non-standard formats/procedures/values etc. The escalation flow comprises sequence of activities performed as a follow up of an activity due to service level/policy violations related to timelines, non-availability, inconsistencies, output quality etc.

For each data used in an activity, the user selects the flow state value as provided by the user interface module 120. In an embodiment, if the value is not available, the parameters and process flow properties are updated.

If the user adds a sub-process as part of parent process canvas, the interaction management computing apparatus 100 opens a new process canvas to add activities using user interface module 120. The user can define the sub-process in the same way an activity is defined in the above steps.

Then, the user selects the stop shape and fills the stop properties which include selecting one or more reasons for stop at each process canvas displayed by the user interface module 120. The interaction management computing apparatus 100 provides a list of data assets which may be optionally selected related to a reason for the stop through the display interface module 128. All the process shapes are stored using the content management module 124 into the memory 108.

In an embodiment, all the information related to the process are provided by the user using at least one of selection of a value from a predefined list of values and input in an input box using a predefined format. The predefined list of values and the input box are displayed on the user interface module 120. As an example, the predefined format is selected from one of text, image, audio and video.

At block 350, update parameters and process flow properties for the process. For each activity, the template engine 126 provides a list of options related to parameters like document, role and system etc. The user selects the relevant data or role or system used in each activity through the user interface module 120. If a particular data or role or system is not available or not defined with sufficient information, the user creates the particular information through the display interface module 128. Similarly, for each activity, if the flow state of a particular data is not defined, the user creates the flow state through the user interface module 120.

At block 360, identify and fix errors in the process. The content preparation module 202 and the validator module 204 of ID generator module 122 runs a predefined set of rules and provides errors/alerts/warnings through the display interface module 128. In an exemplary embodiment, the errors may be generated due to insufficient data for selected level, incomplete or incorrect data, incomplete flows or open ended loops, mandatory data not captured,

A person skilled in the art would understand that the alerts may be generated for any other condition configured in the interaction management computing apparatus 100. The content preparation module 202 and the validator module 204 are scalable to any type of validation checks and preparing content for generating interaction diagram view.

In an embodiment once the errors are detected, the user reconciles or corrects the system identified errors. In an embodiment, the errors may be fixed by updating corresponding document, roles, system or properties related to data elements, flow states etc. through the user interface module 120.

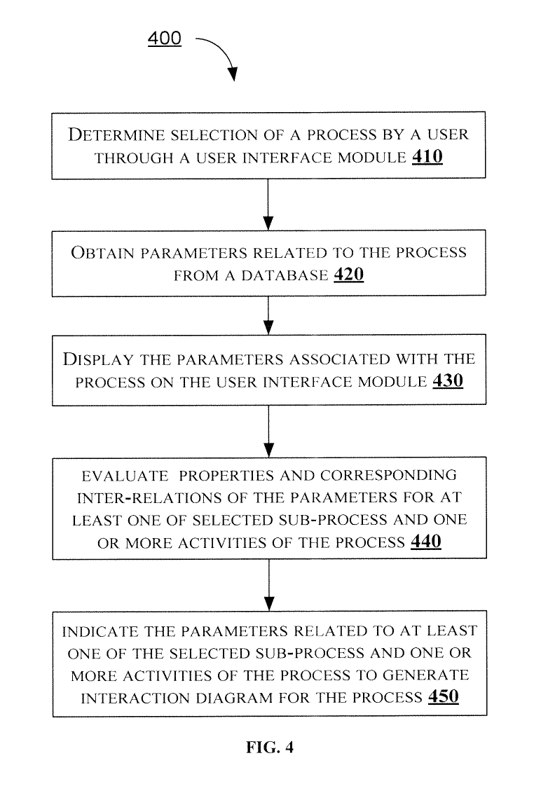

At block 370, generate interaction diagrams for the process. The business interaction diagrams are generated using the content exploration module 206 of ID generator module 122 and displayed to the user through the content evaluation module 208 via the display interface module 128. Once the process steps are detailed, validated and errors in the process are fixed as explained in FIG. 3, the user can view interaction diagrams for the process. The process for generating interaction diagram is illustrated in flowchart 400 of FIG. 4.

The method 400 may be described in the general context of computer executable instructions. Generally, computer executable instructions can include routines, programs, objects, components, data structures, procedures, modules, and functions, which perform particular functions or implement particular abstract data types. The order in which the method 400 is described is not intended to be construed as a limitation, and any number of the described method blocks can be combined in any order to implement the method 400. Additionally, individual blocks may be deleted from the method 400 without departing from the spirit and scope of the subject matter described herein. Furthermore, the method 400 can be implemented in any suitable hardware, software, firmware, or combination thereof.

At block 410, determine selection of a process by a user through the user interface module 120. The user selects a project and a process for which the user needs to view and analyze interaction diagrams.

At block 420, obtain parameters related to the process from the memory. The interaction management computing apparatus 100 extracts all parameters like data involved in the process, different roles and system involved in the process etc.

At block 430, display the parameters associated with the process on the user interface module 120. The interaction management computing apparatus 100 displays all information related to the process through the display interface module 128.

At block 440, evaluate properties and corresponding inter-relations of the parameters for at least one of selected sub-process and one or more activities of the process. In an embodiment, the user selects the process parent canvas or sub-process depending on the requirement from the displayed process. Also, the user selects the view which needs to be displayed from a list of views provided by the user interface module 120. The interaction management computing apparatus 100 extracts all process, document, role and system details at a particular process canvas level through the content preparation module 202 and the content exploration module 206 of ID generator module 122. Also, the interaction management computing apparatus 100 extracts details at any level below the process canvas level if a particular process canvas contains other sub-processes. FIG. 5J illustrates an exemplary screenshot of an activity selected by the user. In the illustrated figure, the user selects the activity “Enter Invoice in ERP”. The system then highlights all the documents, roles and system which are involved in performing the activity. The documents used are payment, the role is treasury clerk and the system is treasury payment system. FIG. 5K illustrates another exemplary screenshot where a parameter is selected by user and corresponding activities and other parameters involved with the selected parameter are highlighted. Here, the selected parameter is role-AP clerk and all the activities performed by AP clerk are highlighted. The interaction management computing apparatus 100 checks collated values as against the views selected using the content evaluation module 210. FIG. 5L illustrates selection of a view from different views available on the system. Table 2 illustrates an exemplary illustration of view of interaction diagrams:

TABLE 2

| | | Sub View- | | |
|---|---|---|---|---|
| Canvas | Views | Level 1 | Level 2 | Information Displayed |
| Process | Sub- | | | Visual display of activities |
| Canvas | Process/ | | | and connection flows |
| View | Activity | | | |
| | Views | | | |
| | Flows | Straight | | Highlight all activities part |
| | | through | | of straight flows |
| | | Exception | | Highlight only exception |
| | | | | activities |
| | | Priority | | Highlight only priority |
| | | | | activities |
| | Scope | Inscope/ | | Highlight activities which |
| | Views | Out Scope | | are out of scope |
| | Process- | | | When User select a Data(s) |
| | Data | | | steps where it is/are used |
| | interaction | | | are highlighted |
| | | | | When the user selects an |
| | | | | activity then the relevant |
| | | | | data is shown |
| | Process- | | | When User select a Role(s) |
| | Role view | | | steps where it is/are used |
| | | | | are highlighted |
| | | | | When the user selects an |
| | | | | activity then the relevant |
| | | | | Role is shown |
| | Process- | | | When User select a |
| | System | | | System(s) steps where it |
| | View | | | is/are used are highlighted |
| | | | | When the user selects an |
| | | | | activity then the relevant |
| | | | | system is shown |
| | Hand-off | Role-to- | | Highlight all Source and |
| | View | Role | | Destination activities |
| | | | | where there is a change in |
| | | | | role in the sequence of |
| | | | | activities |
| | | Department- | | Highlight all source and |
| | | to- | | destination activities |
| | | Department | | where there is a change in |
| | | | | function/department in the |
| | | | | sequence of activities |
| | | System-to- | Same | Highlight all Source and |
| | | System | Role | Destination activities |
| | | | | where there is a change |
| | | | | in system the sequence |
| | | | | of activities (Performed |
| | | | | manually) |
| | | | Auto- | Highlight all Source and |
| | | | mation | Destination activities |
| | | | | where there is a change |
| | | | | in system the sequence |
| | | | | of activities (performed |
| | | | | by system) |
| | Quality | Compliance | | Highlights all activities |
| | | | | related to compliance |
| | | | | activities |
| | | Internal | | highlights all activities |
| | | Controls | | identified as Internal |
| | | | | Controls |
| | | Critical to | | Highlights all activities |
| | | Quality | | identify either as CTQ/ |
| | | (CTQ)/ | | CTP |
| | | Critical to | | |
| | | Process | | |
| | | (CTP) | | |
| | | Value | | Highlights all activities |
| | | Added (VA)/ | | based on VA or NVA |
| | | No Value | | category with different |
| | | Added | | colours and time taken if |
| | | (NVA) | | available |
| | Metrics/ | | | Highlights all activities |
| | Service | | | where key metrics or |
| | Level | | | SLAs are linked |
| | Agreement | | | |
| | (SLA) | | | |
| | Process- | Role + | | When user selects a role |
| | Data Role | System | | and a system all activities |
| | System | | | where role and data used |
| | (DRS) | | | highlighted |
| | Combin- | | | |
| | ation View | | | |
| | (Single | | | |
| | Select) | | | |
| | | Role + Data | | When user selects a role |
| | | | | and a data all activities |
| | | | | where role and data used |
| | | | | highlighted |
| | | Data + | | When user selects a data |
| | | System | | and a system all activities |
| | | | | where data and system |
| | | | | used highlighted |
| | Process- | Multiple | | When user selects a data(s) |
| | DRS Com- | Roles + | | and a system(s) all |
| | bination | Systems | | activities where these are |
| | View | | | used highlighted with |
| | (multi | | | different combinations of |
| | select) | | | data + system |
| | | Multiple | | When user selects a role(s) |
| | | Roles + | | and a data(s) all activities |
| | | Data | | where these are used |
| | | | | highlighted with different |
| | | | | combinations of data + role |
| | | Multiple | | When user selects a data(s) |
| | | Data + | | and a systems(s) all |
| | | Systems | | activities where these are |
| | | | | used highlighted with |
| | | | | different combinations of |
| | | | | data + system |
| | Com- | Completion | | Highlight activities which |
| | pleteness | Process | | are not completed with |
| | View | Properties | | mandatory fields in |
| | | View | | properties |
| | | Completion | | Highlight data which are |
| | | Data | | not completed with |
| | | Properties | | mandatory fields for the |
| | | View | | use within process |
| | | | | context/level of detail |
| | | Completion | | Highlight role which are |
| | | Roles | | not completed with |
| | | Properties | | mandatory fields for the |
| | | View | | use within process |
| | | | | context/level of detail |
| | | Completion | | Highlight system which |
| | | System | | are not completed with |
| | | Properties | | mandatory fields for the |
| | | View | | use within process context |
| | | | | level of detail |
| | Data | Primary/ | | Highlight data assets |
| | Interaction | Reference | | which are primary and |
| | View | View | | references within |
| | | | | process context |
| | | Storage | | Highlight duplicate data |
| | | | | store of data assets within |
| | | | | process context |
| | | Completion | | Highlight data which |
| | | view | | are not completed with |
| | | | | mandatory fields for the |
| | | | | use within process |
| | | | | context/level of detail |
| | | Linkages | | Display the linkages |
| | | | | among the data assets by |
| | | | | activity purpose |
| | | Systems | | Display the systems where |
| | | | | data being handled |
| | | Critical | | highlights critical data |
| | | Data | | within process context |
| | | States | | Display state changes on |
| | | | | data within process context |
| | | | | by activity |
| | Role | Completion | | Highlight role which are |
| | Interaction | view | | not completed with |
| | View | | | mandatory fields for the |
| | | | | use within process |
| | | | | context/level of detail |
| | | Dependency | Approvals | Display roles providing |
| | | view | | key information to other |
| | | | | roles |
| | | | Messages | Display roles providing |
| | | | | key information to other |
| | | | | roles |
| | | Full Time | Count | Display number of FTEs |
| | | Equivalents | | performing specific roles |
| | | (FTEs) | | |
| | | | Profile | Display profiles of FTEs |
| | | | | performing specific roles |
| | | | Location | Display locations of FTEs |
| | | | | performing specific roles |
| | | Critical | | Highlights critical roles |
| | | Roles | | within process context |
| | | Linkages | Modes | Display the linkages |
| | | | | among the roles assets by |
| | | | | activity purpose and mode |
| | | | Activity | Display the linkages |
| | | | | among the roles assets |
| | | | | by purpose of activity |
| | | Compliance | Int | Highlight roles which are |
| | | | Control | to comply with |
| | | | | Segregation of Duties |
| | | | | (SOD) |
| | System | Types | | Highlight systems by |
| | interaction | | | usage type such as |
| | View | | | Enterprise Resource |
| | | | | Planning (ERP)/Work |
| | | | | Force Management |
| | | | | (WFM)/mainframe |
| | | Versions/ | | Display system versions/ |
| | | Instance | | technology/Instance |
| | | Completion | | Highlight systems which |
| | | view | | are not completed with |
| | | | | mandatory fields for the |
| | | | | use within process |
| | | | | context/level of detail |
| | | Linkages | | Display the linkages |
| | | | | among the Systems |
| | | | | assets by activity and |
| | | | | Data being exchanged |
| | | Roles | | List roles which access |
| | | | | the particular system |
| | | Critical | | highlights critical systems |
| | | Systems | | within process context |
| | | Availability | | Display system |
| | | | | availability data |

At block 450, indicate the parameters related to at least one of the selected sub-process and one or more activities of the process to generate interaction diagram for the process. The interaction management computing apparatus 100 displays the results using the display interface module 128. As an example, the results may be displayed by highlighting, lowlighting, indicating distinctly or subtly, indicating with data the shapes/icons in panels related to the process, document, role and system on the process canvas.

### Computer System

FIG. 6 illustrates a block diagram of an exemplary computer system 600 for implementing embodiments consistent with the present disclosure. In an embodiment, the computer system 600 is used to implement the interaction management computing apparatus 100. The virtual services are managed by the computer system 600 to generate interaction diagrams for a process. The computer system 600 may comprise a central processing unit (“CPU” or “processor”) 602. The processor 602 may comprise at least one data processor for executing program components for executing user- or system-generated business processes. A user may include a person, a person using a device such as such as those included in this disclosure, or such a device itself. The processor 602 may include specialized processing units such as integrated system (bus) controllers, memory management control units, floating point units, graphics processing units, digital signal processing units, etc.

The processor 602 may be disposed in communication with one or more input/output (I/O) devices (611 and 612) via I/O interface 601. The I/O interface 601 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 601, the computer system 600 may communicate with one or more I/O devices (611 and 612). For example, the input device 611 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 612 may be a printer, fax machine, video display (e.g., cathode ray tube (CRT), liquid crystal display (LCD), light-emitting diode (LED), plasma, or the like), audio speaker, etc.

In some embodiments, the processor 602 may be disposed in communication with a communication network 609 via a network interface 603. The network interface 603 may communicate with the communication network 609. The network interface 603 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 609 may include, without limitation, a direct interconnection, local area network (LAN), wide area network (WAN), wireless network (e.g., using Wireless Application Protocol), the Internet, etc. Using the network interface 603 and the communication network 609, the computer system 600 may communicate with server 610. In an embodiment, a business process is received from the computer system 600 may be used by various stakeholders, Information Technology (IT) administrators, business analyst, software tester, software developer or end users of an organization.

In some embodiments, the processor 602 may be disposed in communication with a memory 505 (e.g., RAM, ROM, etc. not shown in FIG. 6) via a storage interface 604. The storage interface 604 may connect to memory 605 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 605 may store a collection of program or database components, including, without limitation, user interface application 606, an operating system 607, web server 608 etc. In some embodiments, computer system 600 may store user/application data 606, such as the data, variables, records, etc. as described in this disclosure. Such databases may be implemented as fault-tolerant, relational, scalable, secure databases such as Oracle or Sybase.

The operating system 607 may facilitate resource management and operation of the computer system 600. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 617 may facilitate display, execution, interaction, manipulation, or operation of program components through textual or graphical facilities. For example, user interfaces may provide computer interaction interface elements on a display system operatively connected to the computer system 600, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 600 may implement a web browser 608 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 600 may implement a mail server 619 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 600 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

Examples of advantages of the examples of the present disclosure are illustrated herein.

Examples of the present disclosure provides interaction views which are easy to use yet powerful to address interaction conflicts.

Examples of the present disclosure provides a simple, yet consistent, solution to detail out any sub-process and create interaction diagrams.

Examples of the present disclosure enables storage, reuse, and update of any sub-process without impact on any other sub-process.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described examples of operations is encoded may comprise a computer readable medium or hardware logic. Of course, those skilled in the art will recognize that many modifications may be made to this configuration without departing from the scope of this technology, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of this technology(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an example with several components in communication with each other does not imply that all such components are required. On the contrary a variety of optional components are described to illustrate the wide variety of possible examples of this technology.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other examples of this technology need not include the device itself.

The illustrated operations of FIGS. 3 and 4 show certain events occurring in a certain order. In alternative examples, certain operations may be performed in a different order, modified or removed. Moreover, steps may be added to the above described logic and still conform to the described examples. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of this technology be limited not by this detailed description, but rather by any claims that issue on an application based here on. Accordingly, the disclosure of the examples of this technology is intended to be illustrative, but not limiting, of the scope of this technology, which is set forth in the following claims.

While various aspects and examples have been disclosed herein, other aspects and examples will be apparent to those skilled in the art. The various aspects and examples disclosed herein are for purposes of illustration and are not intended to be limiting, with the true scope and spirit being indicated by the following claims.

What is claimed is:

1. A method for generating interaction diagrams for a process, comprising:
determining, by a processor of an interaction management computing apparatus, a selection of a process from a user through a user interface;
obtaining, by the processor of the interaction management computing apparatus, parameters related to the selected process;
displaying, by the processor of the interaction management computing apparatus, the parameters associated with the selected process on the user interface;
determining, by the processor of the interaction management computing apparatus, properties and corresponding inter-relations of the obtained parameters for at least one of a sub-process or one or more activities of the selected process; and
generating, by the processor of the interaction management computing apparatus, an interaction diagram of one or more of the obtained parameters related to at least one of the one or more sub-processes or the one or more activities of the selected process.

2. The method as claimed in claim 1, wherein a list of the sub-processes and the activities is displayed on the user interface for selection of at least one of the one or more sub-processes or the one or more activities by the user.

3. The method as claimed in claim 1 further comprising providing, by the processor of the interaction management computing apparatus, one or more receiving options on the user interface to receive the obtained parameters along with a definition, properties and inter-relations for the selected process, based on at least one process detailing level.

4. The method as claimed in claim 1 further comprising providing, by the processor of the interaction management computing apparatus, one or more updating options on the user interface to receive updates on the obtained parameters along with a definition, properties and inter-relations for the selected process.

5. The method as claimed in claim 1, further comprising providing, by the processor of the interaction management computing apparatus, one or more scope capturing options of the selected process on the user interface, by defining start and stop properties for the selected process.

6. The method as claimed in claim 1, wherein the selected process is created by steps comprising:
receiving, by the processor of the interaction management computing apparatus, one or more activities;
receiving, by the processor of the interaction management computing apparatus, name, a type and one or more properties for each of the one or more activities;
providing, by the processor of the interaction management computing apparatus, a predefined list of parameters for receiving selection of a value for the parameters for each of the one or more activities;
receiving, by the processor of the interaction management computing apparatus, one or more information related to each of the one or more activities;
providing, by the processor of the interaction management computing apparatus, a list of flow level for enabling the user to select flow level, conditions and corresponding values; and
creating, by the processor of the interaction management computing apparatus, the selected process using the received at least one of one or more activities, name, type and properties of each of the one or more activities, value of parameters, the one or more information, and flow level and corresponding values.

7. The method as claimed in claim 1, wherein information relating to the selected process is received from the user via the user interface at least one of selection of a value from a predefined list of values and input in an input box using a predefined format, wherein the predefined list of values and the input box are displayed on the user interface.

8. The method as claimed in claim 7, wherein the predefined format is selected from at least one of text, image, audio or video.

9. The method as claimed in claim 1 further comprising identifying, by the processor of the interaction management computing apparatus, one or more errors in the obtained parameters.

10. The method as claimed in claim 1, wherein the obtained parameters relate to the activity of the process are indicated by at least one of highlighting or lowlighting the parameters.

11. An interaction management computing apparatus comprising:
at least one processor; and
a memory coupled to the processor which is configured to be capable of executing programmed instructions comprising and stored in the memory to:
determine a selection of a process from a user through a user interface;
obtain parameters related to the selected process;
display the parameters associated with the selected process on the user interface;
determine properties and corresponding inter-relations of the obtained parameters for at least one of a sub-process or one or more activities of the selected process; and
generate an interaction diagram of one or more of the obtained parameters related to at least one of the one or more sub-processes or the one or more activities of the selected process.

12. The computing apparatus as claimed in claim 11, wherein a list of the sub-processes and the activities is displayed on the user interface for selection of at least one of the one or more sub-processes or the one or more activities by the user.

13. The computing apparatus as claimed in claim 11, wherein the processor coupled to the memory is further configured to be capable of executing at least one additional programmed instruction further comprising and stored in the memory to provide one or more receiving options on the user interface to receive the obtained parameters along with a definition, properties and inter-relations for the selected process, based on at least one process detailing level.

14. The computing apparatus as claimed in claim 11, wherein the processor coupled to the memory is further configured to be capable of executing at least one additional programmed instruction further comprising and stored in the memory to provide one or more updating options on the user interface to receive updates on the obtained parameters along with a definition, properties and inter-relations for the selected process.

15. The computing apparatus as claimed in claim 11, wherein the processor coupled to the memory is further configured to be capable of executing at least one additional programmed instruction for creating the selected process further comprising and stored in the memory to:
receive one or more activities;
receive a name, a type and one or more properties for each of the one or more activities;
provide a predefined list of parameters for receiving selection of a value for the parameters for each of the one or more activities;
receive one or more information related to each of the one or more activities;
provide a list of flow level for enabling the user to select flow level, conditions and corresponding values; and
create the selected process using the received at least one of one or more activities, name, type and properties of each of the one or more activities, value of parameters, the one or more information, and flow level and corresponding values.

16. The computing apparatus as claimed in claim 11, wherein the processor coupled to the memory is further configured to be capable of executing at least one additional programmed instruction further comprising and stored in the memory to identify one or more errors in the obtained parameters.

17. The computing apparatus as claimed in claim 11, wherein the processor coupled to the memory is further configured to be capable of executing at least one additional programmed instruction further comprising and stored in the memory to receive from the user via the user interface at least one of selection of a value from a predefined list of values and input in an input box using a predefined format, wherein the predefined list of values and the input box are displayed on the user interface.

18. The computing apparatus as claimed in claim 17, wherein the predefined format is selected from at least one of text, image, audio, or video.

19. A non-transitory computer readable medium having stored thereon instructions for generating interaction diagrams for a process comprising executable code which when executed by a processor, causes the processor to perform steps comprising:
determining a selection of a process from a user through a user interface;
obtaining parameters related to the selected process;
displaying the parameters associated with the selected process on the user interface;
determining properties and corresponding inter-relations of the obtained parameters for at least one of a sub-process or one or more activities of the selected process; and
generating an interaction diagram of one or more of the obtained parameters related to at least one of the one or more sub-processes or the one or more activities of the selected process.

20. The medium as claimed in claim 19, providing one or more provide one or more receiving options on the user interface to receive the obtained parameters along with a definition, properties and inter-relations for the selected process, based on at least one process detailing level.

21. The medium as claimed in claim 19, further comprising identifying one or more errors in the parameters.
